(19) United States
(12) Patent Application Publication
(10) Pub. No.: US 2014/0174819 A1
(43) Pub. Date: Jun. 26, 2014

(54) Cable Assembly

(71) Applicant: Mehri Mafi, San Jose, CA (US)

(72) Inventors: Mehri Mafi, San Jose, CA (US); Maryam Mafi, San Jose, CA (US)

(21) Appl. No.: 14/100,369

(22) Filed: Dec. 9, 2013

Related U.S. Application Data
(60) Provisional application No. 61/848,330, filed on Dec. 26, 2012.

(51) Int. Cl. H01B 7/00

(52) U.S. Cl. CPC H01B 7/0045
USPC 174/72 A

(57) ABSTRACT

A cable assembly helps organize and consolidate a plurality of cables, adapters, and connectors, which transmit power. The plurality of cables includes insulated conductors used to carry electricity. Each cable includes an associated terminal end for joining the cable to a device or to another cable assembly. A pair of terminal ends for the cables includes a variety of connectors and/or adapters. The connectors and/or adapters are operable to join with outlets from a device or another cable assembly. A cable jacket wraps around the cables and connectors and/or adapters to form a single strand. The cable jacket can be color coded to identify the cables and connectors and/or adapters. The single strand of cables provide a plurality of terminal ends, including, plugs, adapters, USB sockets, and chargers. The cable assembly helps consolidates the cables to minimize excessive wiring, terminal connectors, and adapters.

### CROSS-REFERENCE TO RELATED APPLICATIONS

The present Utility patent application claims priority benefit of the U.S. provisional application for patent Ser. No. 61/848,330 titled “Wire Organizer,” filed on Dec. 26, 2012 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a cable assembly. More particularly, the invention relates to a cable assembly that helps organize and consolidate a plurality of cables, adapters, and connections for joining with a plurality of outlets.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that Electrical wiring in general refers to insulated conductors used to carry electricity, and associated devices.

Typically, a cable harness is an assembly of cables or wires which transmit signals or electrical power. The cables are bound together by straps, cable ties, cable lacing, sleeves, electrical tape, conduit, a weave of extruded string, or a combination thereof.

It is well known that alternating current (A/C) power plugs and sockets are devices that allow electrically operated equipment to be connected to the primary alternating current power supply in a building. Electrical plugs and sockets differ in voltage and current rating, shape, size and type of connectors.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, 1C, 1D, 1E, and 1F illustrate detailed perspective views of exemplary cables assemblies, where FIG. 1A illustrates a plurality of adapters, FIG. 1B illustrates a plurality of connectors, FIG. 1C illustrates adapters and connectors on the same terminal end of the cable, FIG. 1D illustrates a plurality of alternating current adapters on a terminal end of the cable, FIG. 1E illustrates triple connectors on a terminal end of the cable, and FIG. 1F illustrates six or more connectors on a terminal end of the cable, in accordance with an embodiment of the present invention;

FIGS. 2A and 2B illustrate detailed perspective views of different cable assemblies joining together, where FIG. 2A illustrates a plurality of alternating current adapters on a terminal end of the cable, and FIG. 2B illustrates a socket from one terminal end of an exemplary cable assembly joining with a plug from a terminal end of another exemplary cable assembly, in accordance with an embodiment of the present invention;

FIG. 3 illustrates a detailed perspective view of exemplary connectors, adapters, plugs, and sockets that may be joined together, or with a device, in accordance with an embodiment of the present invention;

FIGS. 4A, 4B, and 4C illustrate side views of exemplary male and female connectors in the cable assembly, where FIG. 4A illustrates a single cable segment, FIG. 4B illustrates a double cable segment, and FIG. 4C illustrates a triple cable segment, in accordance with an embodiment of the present invention; and

FIG. 5 illustrates a side view of an exemplary cable assembly mounting portion with hooks for mounting to a mounting surface, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of cable assemblies that may be provided by preferred embodiments of the present invention. In one embodiment of the present invention, the cable assembly may help organize and consolidate a plurality of cables, adapters, and connectors, which transmit power. The plurality of cables may include, without limitation, insulated conductors used to carry electricity. Each cable may include an associated terminal end for joining the cable to a device or to another cable assembly. The cable may include wires that carry electricity and data. However, in other embodiments, the cable may include, without limitation, fiber optic cables, plumbing pipes, and air hoses. The adapters and/or connectors may be operable to join with outlets from a device or another cable assembly. In some embodiments, a single strand of cables may provide a plurality of terminal ends, including, without limitation, plugs, adapters, USB sockets, and chargers. The cable assembly may help consolidate the plurality of cables for minimizing excessive wiring, terminal connectors, and adapters.

In some embodiments, the cable assembly consolidates a plurality of cables into at least one strand. A clear or color coded cable jacket may at least partially wrap around the plurality of cables. Each cable inside the cable jacket may be different and have a different function, whereby the color indicates the functionality. For example, without limitation, the gauge of electrical wires, number of electrical wires, voltage rating, and purpose, i.e., ground wire, hot wire, may be determined based on the colors. Each terminal end on the cable may also be configured to join with a different terminal end of another cable assembly. The terminal end of each wire may, include, without limitation, plugs, adapters, USB sockets, and chargers. The reception socket may be from a device, including, without limitation, a television, an automobile, a DVD, a VCR, a camera, a cable box, a video game console, a PS3, and an X Box. The cable assembly may help minimize the amount of individual, loose cables in proximity to the device.

In one embodiment of the present invention, different combinations and subsets of cables and/or terminal ends may be consolidated into the cable jackets. For example, without limitation, a 15 amp/125 volt plug and socket may extend from opposite ends of an insulated cable to form one cable assembly. A second cable assembly may include a plug that joins with the socket of the first cable assembly. The opposite end of the second cable assembly may also include a 20 amp Y-blade adapter, a car recharger, and a 15 amp/125 volt socket, any of which may be joined with the appropriate device, or terminal end of another cable assembly. It is significant to note that any combination of cables, terminal ends, and devices may be utilized with the cable assembly. In any case, the cables are combined within the cable jacket, thereby reducing the number of loose, individual wires substantially.

In another embodiment, a female connector may position on one terminal end, while a plurality of male connectors may extend from the opposite terminal end of the cable. Any one of the plurality of male connectors may join with another cable assembly having a female reception socket on one terminal end, and a plug on the opposite terminal end. In one embodiment, the plurality of cables may join together as single, double, or triple segments. In a single cable segment, a male and a female combine by snapping or threadably engaging each other. The single cable segment may be useful for connections behind wall outlets. A double cable segment may be useful for ceiling outlets. Cleaning the segments may be facilitated by unsnapping them from each other. A triple cable segment may join with a new or older configuration of devices and sockets. In one embodiment, the cable assembly may include a mounting portion for securing to a mounting surface. The mounting portion may utilize fasteners, including, without limitation, hooks, magnets, bolts, and adhesives. In one example, the hooks may help retain the single strand of the cable jacket and the at least one connector and/or adapter.

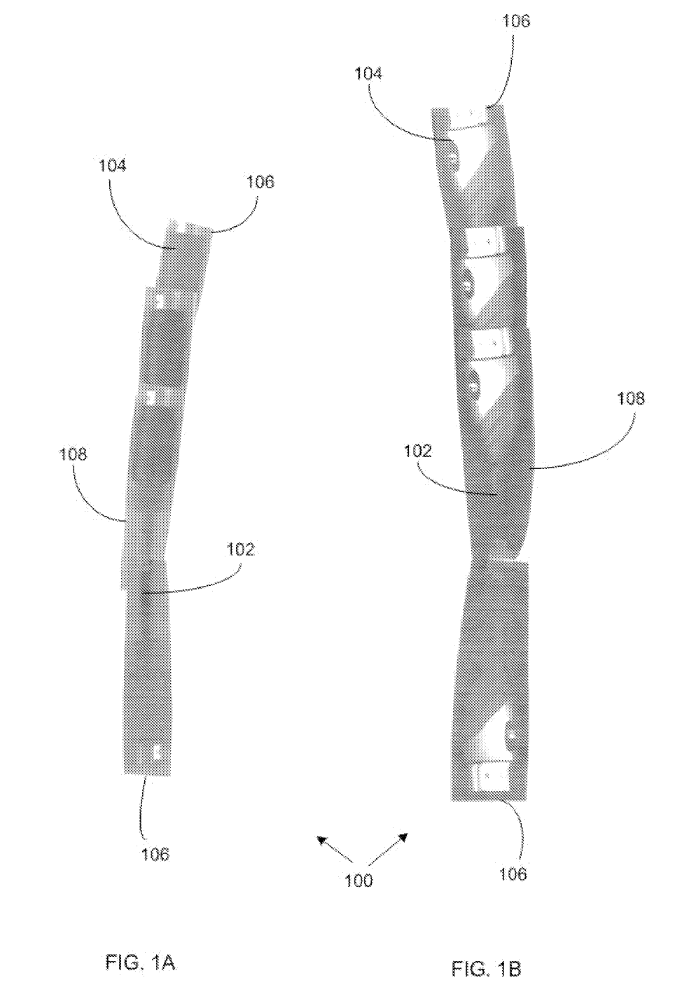

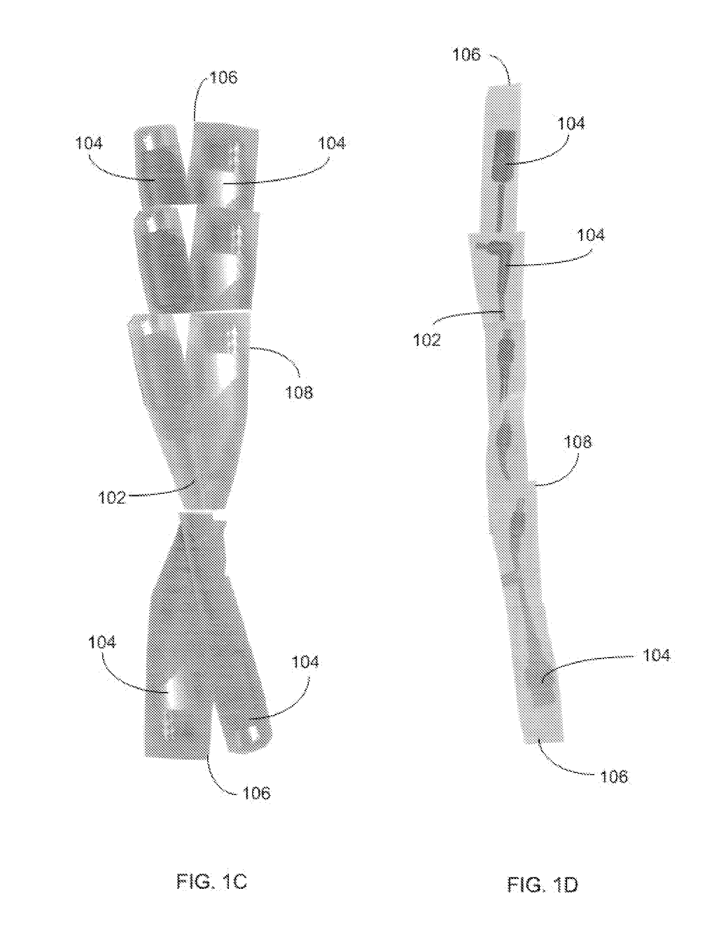

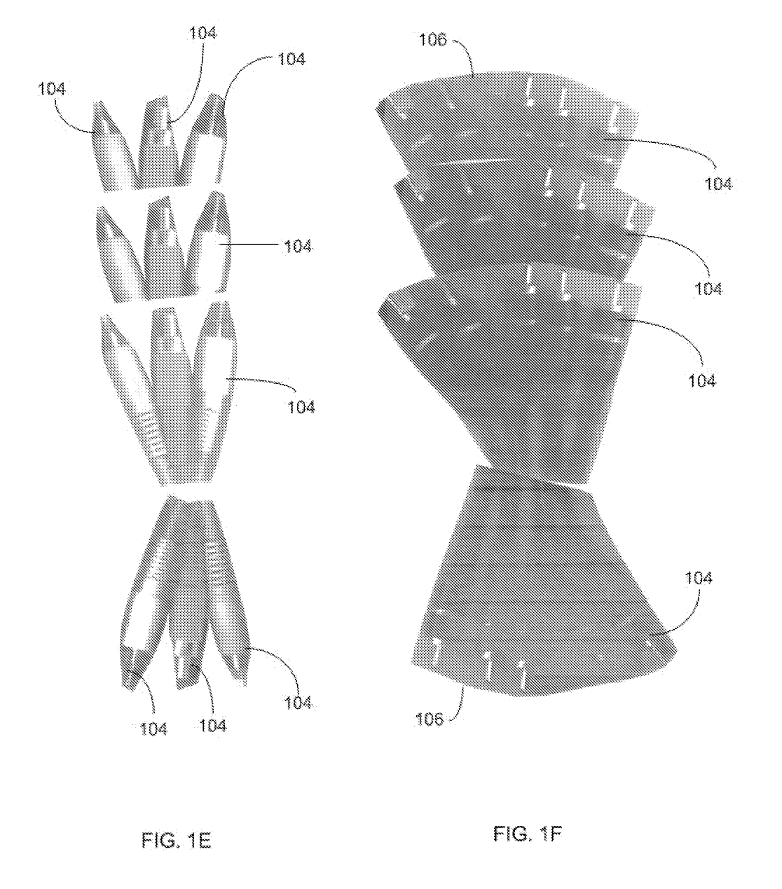

FIGS. 1A, 1B, 1C, 1D, 1E, and 1F illustrate detailed perspective views of exemplary cables assemblies, where FIG. 1A illustrates a plurality of adapters, FIG. 1B illustrates a plurality of connectors, FIG. 1C illustrates adapters and connectors on the same terminal end of the cable, FIG. 1D illustrates a plurality of alternating current adapters on a terminal end of the cable, FIG. 1E illustrates triple connectors on a terminal end of the cable, and FIG. 1F illustrates six or more connectors on a terminal end of the cable, in accordance with an embodiment of the present invention. In the present invention, a cable assembly 100 may help organize and consolidate a plurality of cables 102, and adapters and/or connectors 104, which transmit power. The plurality of cables may include, without limitation, insulated conductors used to carry electricity. Each cable may include a pair of terminal ends 106 for joining the cable to a device or to another cable assembly. The cable may include wires that carry electricity and data. However, in other embodiments, the cable may include, without limitation, fiber optic cables, plumbing pipes, and air hoses. The adapters and/or connectors may be operable to join with outlets from a device or a different cable assembly. In some embodiments, a single strand of cables may provide a plurality of terminal ends having electrical components, including, without limitation, plugs, adapters, USB sockets, and chargers. The cable assembly may help consolidate the plurality of cables for minimizing excessive wiring, terminal connectors, and adapters. Suitable materials for the cable assembly may include, without limitation, plastic, cable wire, polymers, and polyurethane.

In some embodiments, the cable assembly may consolidate a plurality of cables into at least one strand. A cable jacket 108 may at least partially wrap around the plurality of cables. The cable jacket may be clear or color coded. The cable jacket minimizes the need for cable ties, cable lacing, sleeves, or electrical tape to consolidate the plurality of cables and the at least one connector and/or adapter. Each cable inside the cable jacket may be different and have a different function, whereby the color indicates the functionality. For example, without limitation, the gauge of electrical wires, number of electrical wires, voltage rating, and purpose, i.e., ground wire, hot wire, may be determined based on the colors. Each terminal end on the cable may also be configured to join with a different terminal end of a different cable assembly. In this manner, a series of cable assemblies may be formed. The terminal end of each cable may, include, without limitation, plugs, alternating current adapters, USB sockets, and chargers. The reception socket may be from a device, including, without limitation, a television, an automobile, a DVD, a VCR, a camera, a cable box, a video game console, a PS3, and an X Box. The cable assembly may help minimize the amount of individual, loose cables in proximity to the device.

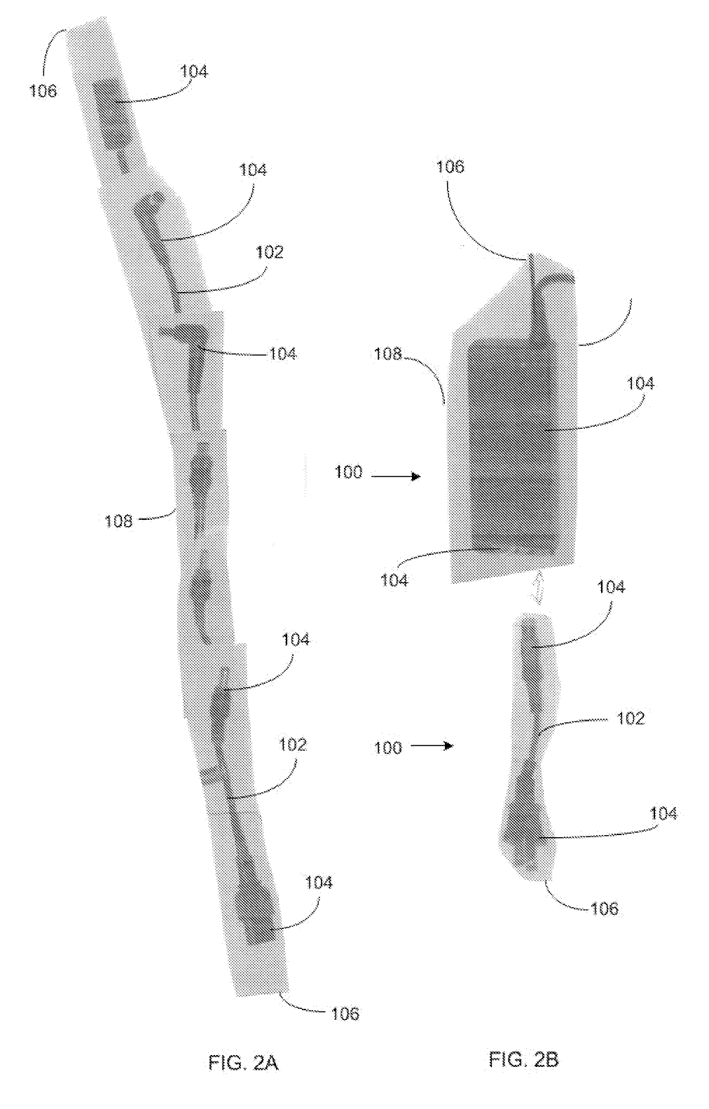

FIGS. 2A and 2B illustrate detailed perspective views of different cable assemblies joining together, where FIG. 2A illustrates a plurality of alternating current adapters on a terminal end of the cable, and FIG. 2B illustrates a socket from one terminal end of an exemplary cable assembly joining with a plug from a terminal end of another exemplary cable assembly, in accordance with an embodiment of the present invention. In the present invention, different combinations and subsets of cables and/or terminal ends may be consolidated into the cable jackets and joined as different cable assemblies. For example, without limitation, an alternating current adapter, a USB bus, and a phone recharger may extend from opposite ends of an insulated cable to form one cable assembly. A second cable assembly may include a USB plug that joins with the socket of the first cable assembly. The opposite end of the second cable assembly may also include a wire terminal, a car recharger, and a 50 amp adapter, any of which may be joined with the appropriate device, or terminal end of another cable assembly. It is significant to note that any combination of cables, terminal ends, and devices may be utilized with the cable assembly. In any case, the cables are combined within the cable jacket, thereby reducing the number of loose, individual wires substantially. In another embodiment, a female connector may position on one terminal end, while a plurality of male connectors may extend from the opposite terminal end of the cable. Any one of the plurality of male connectors may join with another cable assembly having a female reception socket on one terminal end, and a plug on the opposite terminal end.

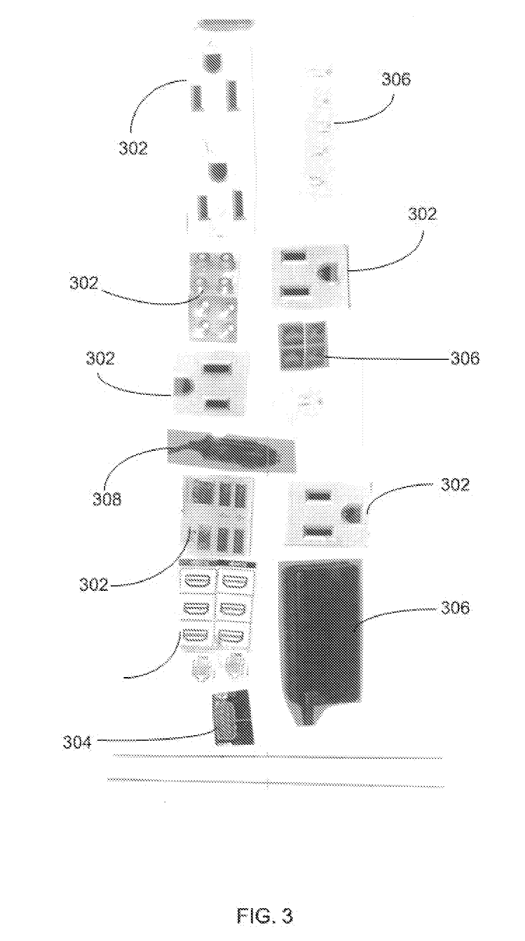

FIG. 3 illustrates a detailed perspective view of exemplary connectors, adapters, plugs, and sockets that may be joined together, or with a device, in accordance with an embodiment of the present invention. In the present invention, the terminal end of each wire may, include an eclectic assortment of at least one connector and/or adapter, including, without limitation, sockets 302, plugs 304, alternating current adapters 306, USB sockets, and chargers 308. Each connector and/or adapter may extend from the respective terminal end. In one embodiment, two or more connectors and/or adapters may extend from each terminal end.

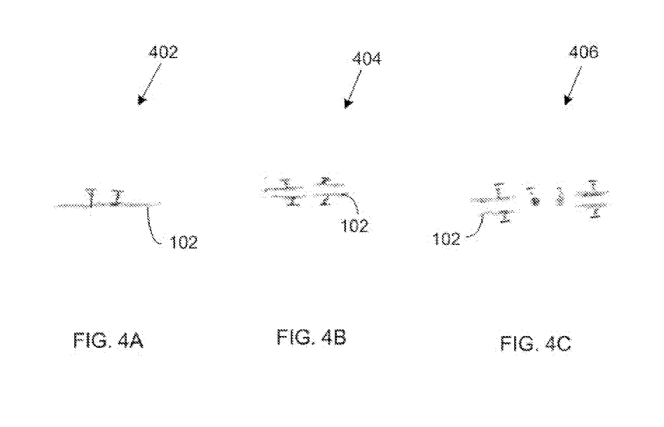

FIGS. 4A, 4B, and 4C illustrate side views of exemplary male and female connectors in the cable assembly, where FIG. 4A illustrates a single cable segment, FIG. 4B illustrates a double cable segment, and FIG. 4C illustrates a triple cable segment, in accordance with an embodiment of the present invention. In the present invention, the plurality of cables may join together as single, double, or triple segments. In a single cable segment 402, a male and a female combine by snapping or threadably engaging each other. The single cable segment may be useful for connections behind wall outlets. A double cable segment 404 may be useful for ceiling outlets. Cleaning the segments may be facilitated by unsnapping them from each other. A triple cable segment 406 may join with a new or older configuration of devices and sockets.

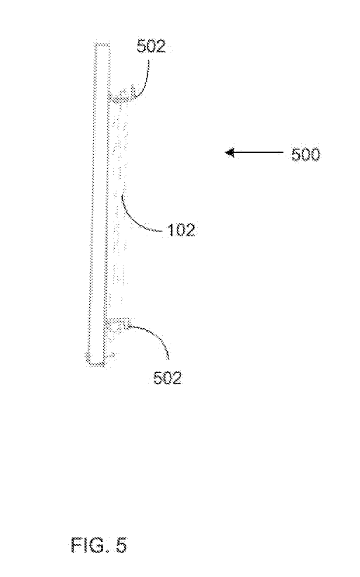

FIG. 5 illustrates a side view of an exemplary cable assembly mounting portion with hooks for mounting to a mounting surface, in accordance with an embodiment of the present invention. In the present invention, the cable assembly may include a mounting portion 500 for securing to a mounting surface. The mounting portion may utilize at least one fastener 502 to secure the cable assembly into a desired position. The at least one fastener may include without limitation, hooks, magnets, bolts, and adhesives. In one example, the hooks may help retain the single strand of the cable jacket and the at least one connector and/or adapter.

In one alternative embodiment, the cable assembly may include a self contained power source for powering the plurality of cables and the at least one adapter and/or connector. In yet another alternative embodiment, the cable assembly may be utilized in telephone cords for joining telephone poles together and transmitting power on a large scale. In yet another alternative embodiment, the plurality of cables may include plumbing pipes and fixtures.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of consolidating a plurality of cables into a single strand having terminal ends with multiple plugs, sockets, adapters, and connectors according to the present invention will be apparent to those skilled in the art. Various aspects of the invention have been described above by way of illustration, and the specific embodiments disclosed are not intended to limit the invention to the particular forms disclosed. The particular implementation of consolidating a plurality of cables into a single strand having terminal ends with multiple plugs, sockets, adapters, and connectors may vary depending upon the particular context or application. By way of example, and not limitation, consolidating a plurality of cables into a single strand having terminal ends with multiple plugs, sockets, adapters, and connectors described in the foregoing were principally directed to a cable assembly that wrapped a plurality of wires, adapters, plugs and sockets into a cable jacket in different combinations implementations; however, similar techniques may instead be applied to pipes for plumbing or fiber optics in a network, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An assembly comprising:
a plurality of cables, said plurality of cables being configured to join together, said plurality of cables comprising a pair of terminal ends, said pair of terminal ends comprising at least one connector and/or adapter, said at least one connector and/or adapter being disposed to join with a device and/or a different assembly; and
a cable jacket, said cable jacket being configured to at least partially enclose said plurality of cables and said at least one connector and/or adapter.

2. The assembly of claim 1, in which said plurality of cables comprise wires and/or circuitry.

3. The assembly of claim 2, in which said cable jacket comprises an insulated polymer that at least partially binds said plurality of cables together.

4. The assembly of claim 3, in which said pair of terminal ends comprises a male connector, and/or a female connector, and/or a socket, and/or a plug, and/or an alternating current adapter, and/or a USB plug.

5. The assembly of claim 4, in which said device comprises a television.

6. The assembly of claim 5, wherein said assembly is configured to join with a different assembly at said pair of terminal ends.

7. The assembly of claim 6, wherein joining said plurality of cables helps minimize said plurality of cables in proximity to said device.

8. The assembly of claim 7, wherein said assembly is operable to join a male wire with a female wire to form a single cable segment, and/or a double cable segment, and/or a triple cable segment.

9. A assembly comprising:
means for binding a plurality of cables, and a connector and/or adapter at least partially within a cable jacket;
means for orienting a pair of terminal ends to join with a device and/or another assembly;
means for mounting said assembly with a mounting portion;
means for joining said connector and/or adapter with a device and/or another assembly; and
means for joining a male wire with a female wire.

10. An assembly consisting of:
a plurality of cables, said plurality of cables comprising wires and/or circuitry, said plurality of cables being configured to join together, said plurality of cables comprising a pair of terminal ends, said pair of terminal ends comprising at least one connector and/or adapter, said at least one connector and/or adapter being disposed to join with a device and/or a different assembly, said pair of terminal ends comprising a male connector, and/or a female connector, and/or a socket, and/or a plug, and/or an alternating current adapter, and/or a USB plug; and
a cable jacket, said cable jacket comprising an insulated polymer that at least partially binds said plurality of cables together, said cable jacket being configured to at least partially enclose said plurality of cables and said at least one connector and/or adapter.
